(19) United States
(12) Patent Application Publication
(10) Pub. No.: US 2020/0082805 A1
(43) Pub. Date: Mar. 12, 2020

(54) SYSTEM AND METHOD FOR SPEECH SYNTHESIS

(71) Applicant: BEIJING DIDI INFINITY TECHNOLOGY AND DEVELOPMENT CO., LTD., Beijing (CN)

(72) Inventors: Hui ZHANG, Beijing (CN); Xiulin LI, Tianjing (CN)

(73) Assignee: BEIJING DIDI INFINITY TECHNOLOGY AND DEVELOPMENT CO., LTD., Beijing (CN)

(21) Appl. No.: 16/684,684

(22) Filed: Nov. 15, 2019

Related U.S. Application Data
(63) Continuation of application No. PCT/CN2017/084530, filed on May 16, 2017.

(51) Int. Cl. G10L 13/08; G10L 13/027; G10L 15/14; G06F 17/27

(52) U.S. Cl. CPC G10L 13/08; G06F 17/277; G10L 15/144; G10L 13/027

(57) ABSTRACT

The present disclosure relates to a method and system for generating a speech from a text. According to certain embodiments, the method includes: identifying a plurality of phonemes from the text; determining a first set of acoustic features for each identified phoneme; selecting a sample phoneme corresponding to each identified phoneme from a speech database based on at least one of the first set of acoustic features; determining a second set of acoustic features for each selected sample phoneme; and generating the speech using a generative model based on at least one of the second set of acoustic features.

### CROSS-REFERENCE TO RELATED APPLICATIONS

This application is a continuation of International Application No. PCT/CN2017/084530 filed on May 16, 2017, which is incorporated herein by reference in its entirety.

### TECHNICAL FIELD

The present disclosure relates to speech synthesis, and more particularly, to systems and methods for synthesizing speech from texts based on a combination of unit-selection and model-based speech generation.

### BACKGROUND

A text-to-speech system can convert a variety of texts into a speech. In general, the text-to-speech system may include a front-end part and a back-end part. The front-end part may include text normalization and text-to-phoneme conversion that converts raw texts into their equivalent written-out words, assigns phonetic transcriptions to each word, and divides and marks the text into prosodic units, such as phrases, clauses, and sentences. The front-end part may output the phonetic transcriptions and prosody information as symbolic linguistic data to the back-end part. The back-end part then converts the symbolic linguistic data into sound based on a synthesis method, such as statistical parametric synthesis or concatenative synthesis methods.

A statistical parametric synthesis method may obtain features of phonemes from the text and predicts phoneme duration, fundamental frequency, and spectrum of each phoneme through a trained machine learning model. However, the predicted phoneme duration, fundamental frequency, and spectrum may be over smoothed by the statistical approach, resulting in serious distortion in synthesized speech. On the other hand, concatenative synthesis method, e.g., unit selection synthesis (USS), may select and concatenate speech units from a database. However, the unit selection approach frequently experiences “jumps” at concatenations, causing the speech to be discontinuous and unnatural. It would be desirable to have a text-to-speech synthesis system that generates speeches with improved qualities

Embodiments of the disclosure provide an improved speech synthesis system and method that takes advantage of both unit-selection from speech database and model-based speech generation.

### SUMMARY

One aspect of the present disclosure is directed to a computer-implemented method for generating a speech from a text. The method includes: identifying a plurality of phonemes from the text; determining a first set of acoustic features for each identified phoneme; selecting a sample phoneme corresponding to each identified phoneme from a speech database based on at least one of the first set of acoustic features; determining a second set of acoustic features for each selected sample phoneme; and generating the speech using a generative model based on at least one of the second set of acoustic features.

Another aspect of the present disclosure is directed to a speech synthesis system for generating a speech from a text. The speech synthesis system includes a storage device configured to store a speech database and a generative model. The speech synthesis system also includes a processor configured to: identify a plurality of phonemes from the text; determine a first set of acoustic features for each identified phoneme; select a sample phoneme corresponding to each identified phoneme from the speech database based on at least one of the first set of acoustic features; determine a second set of acoustic features for each selected sample phoneme; and generate the speech using a generative model based on at least one of the second set of acoustic features.

Yet another aspect of the present disclosure is directed to a non-transitory computer-readable medium that stores a set of instructions, when executed by at least one processor, cause the at least one processor to perform a method for generating a speech from a text. The method includes: identifying a plurality of phonemes from the text; determining a first set of acoustic features for each identified phoneme; selecting a sample phoneme corresponding to each identified phonemes from a speech database based on at least one of the first set of acoustic features; determining a second set of acoustic features for each selected sample phoneme; and generating the speech using a generative model based on at least one of the second set of acoustic features.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates an exemplary speech synthesis system, according to some embodiments of the disclosure.

FIG. 2 is a flowchart of an exemplary method for speech synthesis based on both selected and predicted phonetic parameters, according to some embodiments of the disclosure.

FIG. 3 is a block diagram of an exemplary speech synthesis system, according to some embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

The disclosure is generally directed to a text-to-speech synthesis system and method that may generate a high fidelity speech. In some embodiments, the speech synthesis system may include a synthesis part and a training part. The synthesis part may include a phoneme identification unit that identifies a plurality of phonemes from a text. The synthesis part may further include an acoustic feature determination unit that determines a set of acoustic features for each identified phoneme. In some embodiments, the determined set of acoustic features may include a phoneme duration, a fundamental frequency, a spectrum, or any combination thereof.

The synthesis part may further include a sample phoneme selection unit that selects, from a speech database, a sample phoneme corresponding to each identified phoneme based on at least one of the determined set of acoustic features. In some embodiments, the sample phoneme selection unit may be configured to select a phoneme stored in the speech database that has acoustic features best resembling the acoustic features of the identified phoneme. The sample phoneme selection unit may also be configured to determine an updated set of acoustic features for each selected sample phoneme, and providing the updated set of acoustic features for speech synthesis. In some embodiments, the updated set of acoustic features may have updated values for the phoneme duration, fundamental frequency, spectrum, or any combination thereof. Because the updated set of acoustic features are determined from real phonemes in the speech database, they are more accurate and more natural compared to acoustic features estimated directly from phonemes identified from the text. Accordingly, using the updated acoustic features improves the quality of the synthesized speech.

The training part of the speech synthesis system may include a speech database containing a plurality of speech samples. The training part may also include a feature extraction unit that extracts excitation and spectral parameters of the speech samples in the speech database for training a generative model. The training part may perform a training process that trains a generative model by using the extracted excitation and spectral parameters and labels of training samples from the speech database. Exemplary excitation parameters may include fundamental frequencies, bandpass voicing strengths, and/or Fourier magnitudes. Exemplary spectral parameters may include the spectral envelope in linear predictive coding (LPC) coefficients, and/or cepstral coefficients. Exemplary labels may include context labels, such as previous/current/next phoneme identities, positions of the current phoneme identity in the current syllable, whether the previous/current/next syllable stressed/accented, numbers of phonemes in the previous/current/next syllable, positions of current syllable in the current word/phrase, numbers of stressed/accented syllables before/after the current syllable in the current phrase, numbers of syllables from the previous/current stressed syllable to the current/next syllables, numbers of syllables from the previous accented/current syllables to the current/next accented syllables, names of the vowel of current syllables, predictions of the previous/current/next words, numbers of syllables/words in the previous/current/next words/phrases, positions of the current phrases in the utterance, and/or numbers of syllables/words/phrases in the utterance.

In some embodiments, the training process may be configured to train the generative model by a plurality of spectra of phonemes. In some embodiments, the generative model may be a hidden Markov model (HMM) model or a neural network model. After training, the training part may provide a trained generative model for generating parameters for speech synthesis based on the phonemes of the text.

With the trained generative model, the speech synthesis system may further generate the speech based on at least one of the updated set of acoustic features. In some embodiments, the speech synthesis system may also include text feature extraction that determines a set of text features for each identified phoneme. The text features may be used in addition to the set of acoustic features in order to further improve the speech synthesis.

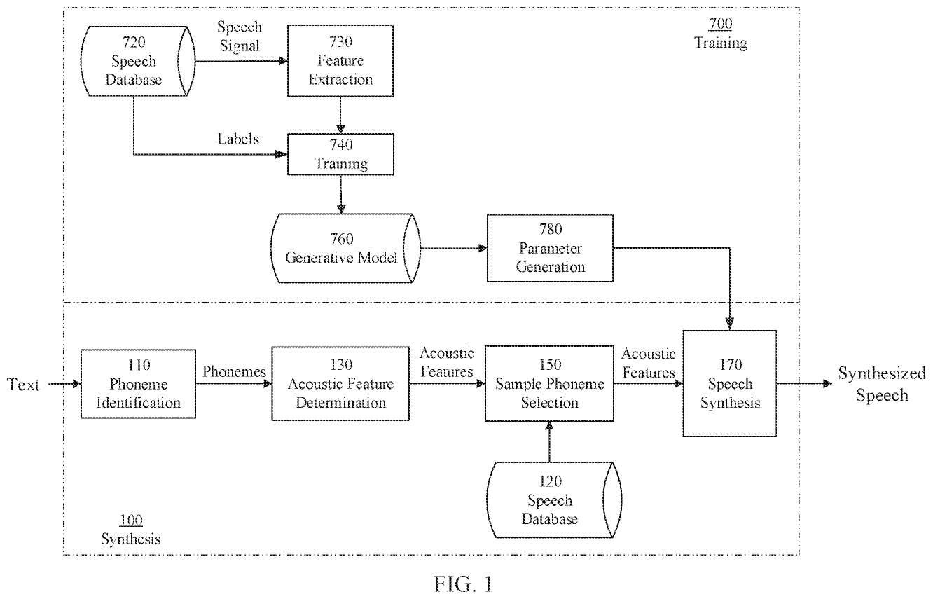

FIG. 1 illustrates an exemplary speech synthesis system, according to some embodiments of the disclosure. The speech synthesis system may include a synthesis part 100 and a training part 700. Although FIG. 1 describes both synthesis part 100 and training part 700 within one system, it is contemplated that the synthesis and training parts may be part of separate systems. For example, training part 700 may be implemented in a server, while synthesis part 100 may be implemented in a terminal device communicatively connected to the server.

In some embodiments, synthesis part 100 may include a phoneme identification unit 110, a speech database 120, an acoustic feature determination unit 130, a sample phoneme selection unit 150, and a speech synthesis unit 170.

Phoneme identification unit 110 may be configured to identify a plurality of phonemes from a text. For example, after receiving the text, phoneme identification unit 110 may be configured to convert the text containing symbols like numbers and abbreviations into their equivalent written-out words as they will be pronounced. Phoneme identification unit 110 may also be configured to assign phonetic transcriptions to each word. Phoneme identification unit 110 may further be configured to divide and marking the text into prosodic units, such as phrases, clauses, and sentences. Accordingly, phoneme identification unit 110 may be configured to identify the plurality of phonemes from the text.

Acoustic feature determination unit 130 may be configured to determine a set of acoustic features for each phoneme identified by phoneme identification unit 110. For example, acoustic feature determination unit 130 may be configured to determine a set of acoustic features containing a phoneme duration, a fundamental frequency, a spectrum, position in the syllable, and/or neighboring phonemes for each identified phoneme by phoneme identification unit 110. In some embodiments, the determined set of acoustic features may include the phoneme duration, the fundamental frequency, the spectrum, or any combination thereof, of the identified phonemes. Acoustic feature determination unit 130 may also be configured to send these sets of acoustic features to sample phoneme selection unit 150.

After obtaining the determined acoustic features of identified phonemes, sample phoneme selection unit 150 may be configured to select a sample phoneme corresponding to each identified phoneme from a speech database based on at least one of the determined set of acoustic features. For example, sample phoneme selection unit 150 may be configured to search for and selecting a sample phoneme in speech database 120 based on phoneme duration, fundamental frequency, and position in the syllable. Speech database 120 may include a plurality of sample phonemes that are obtained from real human speeches, and acoustic features of these sample phonemes.

In some embodiments, sample phoneme selection unit 150 may be configured to select a phoneme stored in the speech database that has acoustic features best resembling the acoustic features of the identified phoneme. For example, sample phoneme selection unit 150 may be configured to select the phoneme in speech database 120 that has a phoneme duration and a fundamental frequency best resembling that of the identified phoneme. In some embodiments, sample phoneme selection unit 150 may also be configured to weigh each of the determined set of acoustic features and select the best resembling one according to the weighted result. A weighting ratio may be determined based on each acoustic feature's impact on speech synthesis.

In addition, sample phoneme selection unit 150 may be configured to determine a set of acoustic features for each selected sample phoneme. For example, after selecting sample phonemes, sample phoneme selection unit 150 may further be configured to determine a set of acoustic features, such as the phoneme duration and fundamental frequency, of the selected sample phonemes to be the acoustic features of phonemes for speech synthesis. In some embodiments, the determined set of acoustic features may include the phoneme duration, the fundamental frequency, the spectrum, or any combination thereof, of the selected sample phonemes.

Training part 700 may include a speech database 720, a feature extraction unit 730, a training unit 740, a generative model 760, and a parameter generation unit 780. Speech database 720 may include a plurality of speech samples from recorded human speeches. These speech samples may be used for training a machine learning model before using the model for speech synthesis.

Feature extraction unit 720 may be configured to extract feature parameters from sample speeches. For example, feature extraction unit 720 may be configured to extract spectral parameters and excitation parameters of sample speeches from speech database 720. In some embodiments, feature extraction unit 720 may be configured to extract acoustic features and/or linguistic features. Exemplary acoustic features may include fundamental frequency and/or phoneme duration. Exemplary linguistic features may include length, intonation, grammar, stress, tone, voicing and/or manner.

Training unit 740 may be configured to train a generative model using a plurality of sample speeches. For example, training unit 740 may be configured to train a generative model by using labels of phonemes obtained from sample speeches and their corresponding extracted excitation parameters and spectral parameters from feature extraction unit 730. In some embodiments, training unit 740 may be configured to train an HMM-based generative model, such as a context-dependent subword HMM model and a model combining HMM and decision tree. In some embodiments, training unit 720 may be configured to train a neural network model, such as a feed forward neural network (FFNN) model, a mixture density network (MDN) model, a recurrent neural network (RNN) model, and a highway network model.

In some embodiments, training unit 740 may be configured to train the generative model using a plurality of spectra of phonemes. For example, training unit 740 may be configured to train generative model 760 using the spectra of phonemes obtained from the sample speeches in speech database 720. In some embodiments, generative model 760 trained by using spectra of phonemes may be less complicated and less computationally expensive, compared to that trained by using text features.

Once the training process converges, generative model 760 may include a trained generative model that may generate predicted parameters for speech synthesis according to labels of phonemes from the text. In some embodiments, generative model 760 may include a trained HMM-based generative model, such as a trained context-dependent subword HMM model and a trained model combining HMM and decision tree. In some embodiments, generative model 760 may include a trained neural network model, such as a trained FFNN model, a trained MDN model, a trained RNN model, and a trained highway network model.

Parameter generation unit 780 may be configured to generate predicted parameters, by using generative model 760, for speech synthesis based on the labels of phonemes from the text (not shown). The generated parameters for speech synthesis may include predicted linguistic features and/or predicted acoustic features. These predicted linguistic features and predicted acoustic features may be sent to speech synthesis unit 170 for speech synthesis.

Speech synthesis unit 170 may be configured to obtain the determined set of acoustic features for each selected sample phoneme from sample phoneme selection unit 150 and the predicted linguistic and acoustic parameters from parameter generation unit 780. Speech synthesis unit 170 may be configured to generate the speech using generative model 760 based on at least one of the determined set of acoustic features from sample phoneme selection unit 150. In other words, speech synthesis unit 170 may be configured to use the acoustic features of the selected sample phonemes in generating the speech, instead of using the predicted acoustic features from parameter generation unit 780. These acoustic features of the selected sample phonemes are extracted from sample phonemes of real human speeches. They may provide real and thus more accurate acoustic features for speech synthesis, compared to the predicted acoustic features from parameter generation unit 780. The predicted acoustic features may be over smoothed because they are generated by statistically trained generative model 760.

For example, speech synthesis unit 170 may be configured to generate the speech by using the phoneme duration and the fundamental frequency of the selected sample phonemes, instead of using the predicted phoneme duration and the predicted fundamental frequency. The predicted phoneme duration and fundamental frequency are statistical parameters, not parameters from real human speeches. Accordingly, speech synthesis unit 170 may generate speeches that better resemble real human speeches.

In some embodiments, phoneme identification unit 110 may also be configured to divide each identified phoneme into a plurality of frames. Phoneme identification unit 110 may also be configured to determine a set of acoustic features for each frame. Sample phoneme selection unit 150 may be configured to select the plurality of sample phonemes is based on at least one of the set of acoustic features for frames. Similarly, the operations of the other units may be performed based on frames.

In some embodiments, phoneme identification unit 110 may also be configured to determine a set of text features for each identified phoneme. Speech synthesis unit 170 may further be configured to generate the speech based on the text features determined for the identified phonemes. For example, phoneme identification unit 110 may further be configured to determine a set of text features for each phoneme identified and sending the sets of text features to speech synthesis unit 170. Speech synthesis unit 170 may be configured to generate the speech based on the sets of text features as well as the above predicted linguistic features and selected acoustic features.

In some embodiments, speech synthesis unit 170 may be configured to generate the speech based on the above spectral parameters, instead of the text features while using the spectral parameters in training the generative model. For example, when training unit 740 trains generative model 760 using the spectra of phonemes extracted from sample speeches of speech database 720, speech synthesis unit 170 may be configured to generate the speech based on the spectra of the selected sample phonemes from sample phoneme selection unit 150.

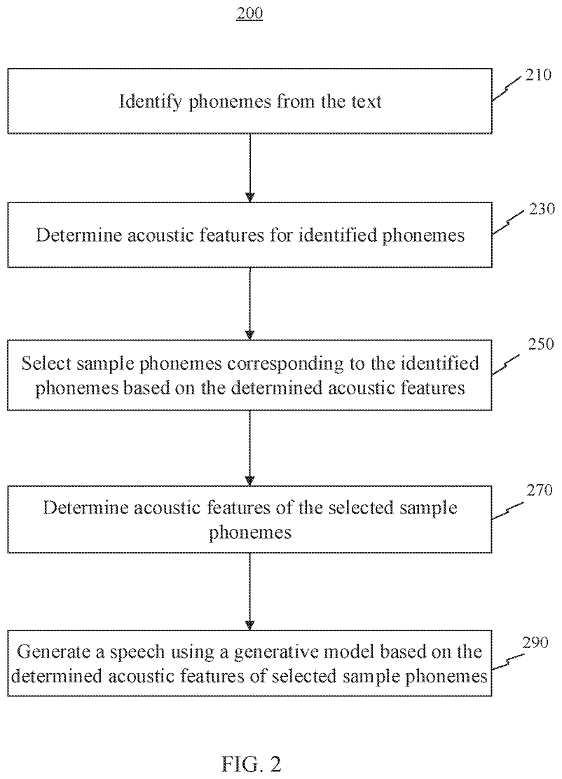

FIG. 2 is a flowchart of an exemplary method for speech synthesis based on both selected and predicted phonetic parameters, according to some embodiments of the disclosure.

Step 210 may include identifying phonemes from a text. In some embodiments, identifying phonemes from the text of step 210 may include identifying a plurality of phonemes from the text. For example, identifying phonemes from the text of step 210 may include converting the text containing symbols like numbers and abbreviations into their equivalent written-out words. Identifying phonemes from the text of step 210 may also include assigning phonetic transcriptions to each word. Identifying phonemes from the text of step 210 may include further dividing and marking the text into prosodic units, such as phrases, clauses, and sentences.

Step 230 may include determining acoustic features for identified phonemes. In some embodiments, determining acoustic features of step 230 may include determining a set of acoustic features for each phoneme identified by step 210. For example, determining acoustic features of step 230 may include determining a set of acoustic features containing a phoneme duration, a fundamental frequency, a spectrum, position in the syllable, and/or neighboring phonemes for each phoneme identified by step 210. In some embodiments, the determined set of acoustic features may include the phoneme duration, the fundamental frequency, the spectrum, or any combination thereof, of the identified phonemes.

Step 250 may include selecting sample phonemes corresponding to the identified phonemes based on the determined acoustic features. In some embodiments, selecting sample phonemes of step 250 may include selecting a sample phoneme corresponding to each identified phoneme from a speech database based on at least one of the determined set of acoustic features. For example, selecting sample phonemes of step 250 may include searching for and selecting a sample phoneme in speech database 120 shown in FIG. 1 based on phoneme duration, fundamental frequency, and position in the syllable. Speech database 120 may include a plurality of sample phonemes that are obtained from real human speeches, and acoustic features of these sample phonemes.

In some embodiments, selecting sample phonemes of step 250 may include selecting a phoneme stored in the speech database that has acoustic features best resembling the acoustic features of the identified phoneme. For example, selecting sample phonemes of step 250 may include selecting the phoneme in speech database 120 that has a phoneme duration and a fundamental frequency best resembling that of the identified phoneme. Selecting sample phonemes of step 250 may include weighing each of the determined set of acoustic features and selecting the best resembling one according to the weighted result. A weighting ratio may be determined based on each acoustic feature's impact on speech synthesis.

Step 270 may include determining acoustic features of the selected sample phonemes. In some embodiments, determining acoustic features of the selected sample phonemes of step 270 may include determining a set of acoustic features for each sample phoneme selected by step 250. For example, determining acoustic features of the selected sample phonemes of step 270 may include determining a set of acoustic features, such as the phoneme duration and fundamental frequency, of the selected sample phonemes in step 250 to be the acoustic features of phonemes for speech synthesis. In some embodiments, the determined set of acoustic features may include the phoneme duration, the fundamental frequency, the spectrum, or any combination thereof, of the selected sample phonemes.

Step 290 may include generating a speech using a generative model based on the determined acoustic features of selected sample phonemes. In some embodiments, generating the speech of step 290 may include obtaining the determined set of acoustic features for each selected sample phoneme by step 250 and the predicted linguistic and acoustic parameters from a trained generative model. Generating the speech of step 290 may include generating the speech using a trained generative model based on at least one of the set of acoustic features determined in step 250. In other words, generating the speech of step 290 may include using the acoustic features of the selected sample phonemes in generating the speech, instead of using the predicted acoustic features. These acoustic features of the selected sample phonemes may be extracted from sample phonemes of real human speeches. They may provide real acoustic features for speech synthesis, compared to the predicted acoustic features. The predicted acoustic features may be over smoothed because they may be generated by a statistically trained generative model.

For example, generating the speech of step 290 may include generating the speech by using the phoneme duration and the fundamental frequency of the selected sample phonemes, instead of using the predicted phoneme duration and the predicted fundamental frequency. The predicted phoneme duration and fundamental frequency are statistical parameters, not parameters from real human speeches. Accordingly, step 290 may generate speeches that better resemble human speeches.

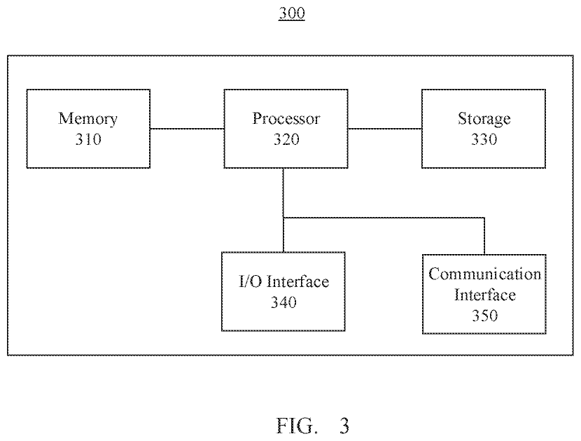

FIG. 3 illustrates an exemplary speech synthesis system 300, according to some embodiments of the disclosure. In some embodiments, speech synthesis system 300 may include a memory 310, a processor 320, a storage 330, an I/O interface 340, and a communication interface 350. One or more of the components of speech synthesis system 300 may be included for converting a text to speech. These components may be configured to transfer data and send or receive instructions between or among each other.

Processor 320 may include any appropriate type of general-purpose or special-purpose microprocessor, digital signal processor, or microcontroller. Processor 320 may be configured to identify phonemes from a text. In some embodiments, processor 320 may be configured to identify a plurality of phonemes from the text. For example, processor 320 may be configured to convert the text containing symbols like numbers and abbreviations into their equivalent written-out words. Processor 320 may also be configured to assign phonetic transcriptions to each word. Processor 320 may further be configured to divide and mark the text into prosodic units, such as phrases, clauses, and sentences.

Processor 320 may also be configured to determine acoustic features for identified phonemes. In some embodiments, processor 320 may be configured to determine a set of acoustic features for each identified phoneme. For example, processor 320 may be configured to determine a set of acoustic features containing a phoneme duration, a fundamental frequency, a spectrum, position in the syllable, and/or neighboring phonemes for each identified phoneme. In some embodiments, the determined set of acoustic features may include the phoneme duration, the fundamental frequency, the spectrum, or any combination thereof, of the identified phonemes.

Processor 320 may also be configured to select sample phonemes corresponding to the identified phonemes based the determined acoustic features. In some embodiments, processor 320 may be configured to select a sample phoneme corresponding to each identified phoneme from a speech database based on at least one of the determined set of acoustic features. For example, processor 320 may be configured to search for and select a sample phoneme in a speech database stored in memory 310 and/or storage 330 based on phoneme duration, fundamental frequency, and position in the syllable. The speech database may include a plurality of sample phonemes that may be obtained from real human speeches, and acoustic features of these sample phonemes.

In some embodiments, processor 320 may be configured to select a phoneme stored in the speech database that has acoustic features best resembling the acoustic features of the identified phoneme. For example, processor 320 may be configured to select the phoneme in the speech database that has a phoneme duration and a fundamental frequency best resembling that of the identified phoneme. In some embodiments, processor 320 may be configured to weigh each of the determined set of acoustic features and to select the best resembling one according to the weighted result. A weighting ratio may be determined based on each acoustic feature's impact on speech synthesis.

In addition, processor 320 may be configured to determine acoustic features of the selected sample phonemes. In some embodiments, processor 320 may be configured to determine a set of acoustic features for each selected sample phoneme. For example, processor 320 may be configured to determine a set of acoustic features, such as the phoneme duration and fundamental frequency, of the selected sample phonemes to be the acoustic features of phonemes for speech synthesis. In some embodiments, the determined set of acoustic features may include the phoneme duration, the fundamental frequency, the spectrum, or any combination thereof, of the selected sample phonemes.

Moreover, processor 320 may be configured to generate a speech using a generative model based on the determined acoustic features of selected sample phonemes. In some embodiments, processor 320 may be configured to obtain the determined set of acoustic features for each selected sample phoneme and the predicted linguistic and acoustic parameters from a trained generative model. Processor 320 may be configured to generate the speech using a trained generative model based on at least one of the set of determined acoustic features. In other words, processor 320 may be configured to use the acoustic features of the selected sample phonemes in generating the speech, instead of using the predicted acoustic features. These acoustic features of the selected sample phonemes may be extracted from sample phonemes of real human speeches. They may provide real acoustic features for speech synthesis, compared to the predicted acoustic features. The predicted acoustic features may be over smoothed because they may be generated by a statistically trained generative model.

For example, processor 320 may be configured to generate the speech by using the phoneme duration and the fundamental frequency of the selected sample phonemes, instead of using the predicted phoneme duration and the predicted fundamental frequency. The predicted phoneme duration and fundamental frequency are statistical parameters, not parameters of real human speeches. Accordingly, processor 320 may be configured to generate speeches that better resemble real human speeches.

Memory 310 and storage 330 may include any appropriate type of mass storage provided to store any type of information that processor 320 may need to operate. Memory 310 and storage 330 may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. Memory 310 and/or storage 330 may be configured to store one or more computer programs that may be executed by processor 320 to perform exemplary speech synthesis method disclosed in this application. For example, memory 310 and/or storage 330 may be configured to store program(s) that may be executed by processor 420 to synthesize the speech from the text, as described above.

Memory 310 and/or storage 330 may be further configured to store information and data used by processor 320. For instance, memory 310 and/or storage 330 may be configured to store speech database 120 and speech database 720 shown in FIG. 1, the identified phonemes from the text, the selected sample phonemes, the set of selected acoustic features of the identified phonemes, the set of selected acoustic features of the selected sample phonemes, the extracted excitation and spectral parameters, trained generative model 760 shown in FIG. 1, predicted linguistic and acoustic features, and text features.

I/O interface 340 may be configured to facilitate the communication between speech synthesis system 300 and other apparatuses. For example, I/O interface 340 may receive a text from another apparatus, e.g., a computer. I/O interface 340 may also output synthesized speech to other apparatuses, e.g., a laptop computer or a speaker.

Communication interface 350 may be configured to communicate with a text-to-speech synthesis server. For example, communication interface 350 may be configured to connect to a text-to-speech synthesis server for access speech database 120 and/or speech database 720 through a wireless connection, such as Bluetooth, Wi-Fi, and cellular (e.g., GPRS, WCDMA, HSPA, LTE, or later generations of cellular communication system) connection, or a wired connection, such as a USB line or a Lightning line.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed speech synthesis system and related methods. Other embodiments will be apparent to those skilled in the art from consideration of the specification and practice of the disclosed speech synthesis system and related methods. Although the embodiments are described using speech as an example, the described synthesis systems and methods can be applied to generate other audio signals from texts. For example, the described systems and methods may be used to generate songs, radio/TV broadcasts, presentations, voice messages, audio books, navigation voice guides, etc.

It is intended that the specification and examples be considered as exemplary only, with a true scope being indicated by the following claims and their equivalents.

What is claimed is:

1. A computer-implemented method for generating a speech from a text, the method comprising:
identifying a plurality of phonemes from the text;
determining a first set of acoustic features for each identified phoneme;
selecting a sample phoneme corresponding to each identified phoneme from a speech database based on at least one of the first set of acoustic features;
determining a second set of acoustic features for each selected sample phoneme; and
generating the speech using a generative model based on at least one of the second set of acoustic features.

2. The computer-implemented method of claim 1, wherein the first set of acoustic features includes a first phoneme duration, a first fundamental frequency, a first spectrum, or any combination thereof.

3. The computer-implemented method of claim 2, wherein the second set of acoustic features includes a second phoneme duration, a second fundamental frequency, a second spectrum, or any combination thereof.

4. The computer-implemented method of claim 1, further comprising: dividing each identified phoneme into a plurality of frames; and determining a third set of acoustic features for each frame, wherein selecting the sample phoneme is based on at least one of the third set of acoustic features.

5. The computer-implemented method of claim 1, further comprising:
determining a set of text features for each identified phoneme,
wherein generating the speech is further based on the text features determined for the identified phonemes.

6. The computer-implemented method of claim 1, wherein selecting the sample phoneme further comprises selecting a phoneme stored in the speech database that has acoustic features best resembling the acoustic features of the identified phoneme.

7. The computer-implemented method of claim 1, wherein the generative model is a hidden Markov model (HMM) model or a neural network model.

8. The computer-implemented method of claim 1, further comprising:
training the generative model using a plurality of training samples from the speech database,
wherein the plurality of training samples include a plurality of spectra of phonemes.

9. The computer-implemented method of claim 8, wherein generating the speech comprises generating the speech by using the trained generative model based on the spectra of the selected sample phonemes.

10. A speech synthesis system for generating a speech from a text, the speech synthesis system comprising:
a storage device configured to store a speech database and a generative model; and a processor configured to:
identify a plurality of phonemes from the text;
determine a first set of acoustic features for each identified phoneme;
select a sample phoneme corresponding to each identified phoneme from the speech database based on at least one of the first set of acoustic features;
determine a second set of acoustic features for each selected sample phoneme; and
generate the speech using a generative model based on at least one of the second set of acoustic features.

11. The speech synthesis system of claim 10, wherein the first set of acoustic features includes a first phoneme duration, a first fundamental frequency, a first spectrum, or any combination thereof.

12. The speech synthesis system of claim 11, wherein the second set of acoustic features includes a second phoneme duration, a second fundamental frequency, a second spectrum, or any combination thereof.

13. The speech synthesis system of claim 10, wherein the processor is further configured to:
divide each identified phoneme into a plurality of frames; and determine a third set of acoustic features for each frame,
wherein the operation of selecting the sample phoneme is based on at least one of the third set of acoustic features.

14. The speech synthesis system of claim 10, wherein the processor is further configured to:
determine a set of text features for each identified phoneme,
wherein the operation of generating the speech is further based on the text features determined for the identified phonemes.

15. The speech synthesis system of claim 10, wherein the operation of selecting the sample phoneme further comprises selecting a phoneme stored in the speech database that has acoustic features best resembling the acoustic features of the identified phoneme.

16. The speech synthesis system of claim 10, wherein the generative model is a hidden Markov model (HMM) model or a neural network model.

17. The speech synthesis system of claim 10, wherein the processor is further configured to:
train the generative model using a plurality of training samples from the speech database, wherein the plurality of training samples include a plurality of spectra of phonemes.

18. The speech synthesis system of claim 17, wherein the processor is configured to:
generate the speech by using the trained generative model based on the spectra of the selected sample phonemes.

19. A non-transitory computer-readable medium that stores a set of instructions, when executed by at least one processor, cause the at least one processor to perform a method for generating a speech from a text, the method comprising:
identifying a plurality of phonemes from the text;
determining a first set of acoustic features for each identified phoneme;
selecting a sample phoneme corresponding to each identified phonemes from a speech database based on at least one of the first set of acoustic features;
determining a second set of acoustic features for each selected sample phoneme; and
generating the speech using a generative model based on at least one of the second set of acoustic features.

20. The non-transitory computer-readable medium of claim 19, wherein the method further comprises:
training the generative model using a plurality of training samples from the speech database, wherein:
the plurality of training samples include a plurality of spectra of phonemes, and
generating the speech includes generating the speech by using the trained generative model based on the spectra of the selected sample phonemes.
